(19) United States
(12) Patent Application Publication
(10) Pub. No.: US 2012/0061377 A1
(43) Pub. Date: Mar. 15, 2012

(54) THERMAL PROCESSING APPARATUS WITH OPTIMIZED STRUCTURAL SUPPORT MECHANISM

(76) Inventors: Mitch Agamohamadi, Orange, CA (US); Saeed Sedehi, Orange, CA (US)

(21) Appl. No.: 13/230,839

(22) Filed: Sep. 12, 2011

Related U.S. Application Data
(60) Provisional application No. 61/381,876, filed on Sep. 10, 2010.

(51) Int. Cl. H05B 3/68

(52) U.S. Cl. 219/468.1

(57) ABSTRACT

A thermal processing apparatus is disclosed which separates the load bearing components from the thermal components, improving heating time, cooling time, thermal response, and energy efficiency. The thermal processing apparatus comprises an array of cylindrical heating elements which rest on support plates of high temperature, low density material. The support plates and heating elements are then supported by a rigid skeletal structure for load bearing support.

### CROSS-REFERENCE TO RELATED APPLICATIONS

This application claims the benefit of U.S. Provisional Patent Application No. 61/381,876, filed on Sep. 10, 2010, and incorporated herein by reference.

### STATEMENT REGARDING FEDERALLY SPONSORED RESEARCH AND DEVELOPMENT

Not Applicable.

### FIELD OF THE INVENTION

This invention relates to an improved thermal processing apparatus and process for heat treatment of semiconductor and solar substrates.

### DISCUSSION OF RELATED ART

Heating systems are commonly used in many different applications. In the semiconductor and solar substrate processing industry, the heating systems are used to anneal or grow films with a specific gas or vapor onto a semiconductor substrate, or wafer, for achieving desired electrical properties. Furthermore, the annealing process is performed for a predetermined amount of time to cure the already grown films on the substrate to improve the film quality and performance.

The wafers are typically heat treated in large numbers, one above the other, in a cylindrical array spaced apart by a certain pitch. The batch of wafers is isolated from outside particles and contamination by a process tube, and a process gas is introduced at a precise flow rate into the process tube from an inlet and exhausted from an outlet.

The temperature range can vary from 200 degrees C. to 1300 degrees C. for different applications and process steps. The heating systems are required to be responsive to temperature changes and maintain a uniform temperature throughout the process in order to achieve a desired film thickness. As such, the temperature accuracy and uniformity across the load of substrate wafers from end to end and within a given substrate is critical in film uniformity and quality.

In typical heating systems, trays or blocks are used to support the heating elements and to provide load bearing support for the entire heating system. To perform both of these tasks, the trays or blocks are made from high temperature and high density materials having a high thermal mass. As such, extra energy is stored in the trays or blocks. Several attempts have been made to reduce the amount of heat that is obstructed and stored, but these designs are restricted because of the load bearing requirements of the trays or blocks.

U.S. Pat, No. 2,035,306 to Fannin on Mar. 24, 1936, describes a furnace intended for the metal melting industry, where refractory blocks of porcelain are placed circumferentially end to end and one on the other to form a continuous groove providing a space for insertion of continuous flat ribbon heating element after the blocks are placed in their operating positions. These blocks are stacked in a loose manner to allow them to expand and contract freely. This furnace has a high thermal mass that stores extra energy in its own body, lowers the thermal response time of the heating apparatus during ramp up, increases the temperature stabilization time, and increases the cool down time. These factors result in increased processing time and higher energy costs.

U.S. Pat. No. 6,005,255 to Kowalski et al. on Dec. 21, 1999, describes a furnace intended for treating semiconductor wafers, where helicoids are placed in high temperature insulation trays that are stacked on top of each other to create the structure of the furnace. The structure works as a load bearing body to build the heat treatment apparatus, as insulation to maintain the precise temperatures that are required for the heat treatment of the substrates, and as a retainer to hold the helicoids in place. The coupling of load bearing and thermal dynamic functions require that the trays have higher density to carry the structural load, which lowers thermal response time, increases temperature stabilization time, and increases cool down time. These factors result in increased processing time and higher energy costs.

U.S. Pat. No. 6,807,220 to Peck on Oct. 19, 2004, describes a furnace intended for treating semiconductor wafers, where wired helical heating elements are encircled by thermal insulation and ceramic spacers are used for spacing the heating elements apart. As the wires are wound, the separators are placed on top of each other to create a stack of separators, with a guide rod keeping each separator in its intended vertical position. This type of straight wire heating has a higher failure rate due to the expansion and elongation of the wire, which is constrained by the separators, causing buckling between the separator columns. Lastly, the separators come in direct contact with the heating element, requiring a higher density material to be used.

Therefore, a need exists for a heat treatment apparatus that can provide more uniform and efficient heating across a large batch of substrates by separating the load bearing support from the heating element support, resulting in better device production yield and lower energy costs. The present invention accomplishes these objectives.

### SUMMARY OF THE INVENTION

The present invention comprises a thermal processing apparatus used for heating substrates such as semiconductor devices, solar cells, LEDs, MEMs, and other substrates. The thermal processing apparatus uniquely decouples the thermal mass from the structural strength of the apparatus. Therefore, the thermal processing apparatus is divided into a skeletal frame structure and an array of heating element support plates.

The skeletal structure has a minimum mass and provides structural support to carry the load of the heating elements and their circular support plates. As such, the support plates do not have any load bearing functions. This is true for the insulation material on the outside of heating element as well. Therefore, the choice of the material for the skeletal structure and insulation can be of a low mass to increase the efficiency of heating and cooling of the substrates.

In one embodiment, the support plates have the role of retaining the heating elements in their radial position. The skeletal structure maintains the support plates on their inner and outer circumferences, while the support plates retain the heating elements with edges or lips on their inner circumference. The skeletal structure is stacked, and each support module contains one or several pieces. The shape of the skeletal structure can be circular or rectangular.

In an alternative embodiment, there is a single heating element which travels to adjacent support plates by gaps within the support plates. The skeletal structure has the role of retaining the heating element in its radial position. The skeletal structure maintains the support plates on their inner and outer circumferences and prevents the heating element from coming in contact with the substrate. The support plates are flat and have no lips or edges. The skeletal structure is stacked, and each support module contains one or several pieces. The shape of the skeletal structure can be circular or rectangular.

These and other objectives of the present invention will become obvious to those of ordinary skill in the art after reading the following detailed description of the preferred embodiments. It is to be understood that the foregoing general description and the following detailed description are exemplary, and are intended to provide further explanation of the invention as claimed.

### DESCRIPTION OF THE DRAWINGS

FIG. 1 is a front perspective view of the thermal processing apparatus according to one embodiment of the invention;

FIG. 2 is a front cross-sectional diagram, taken generally along lines 2-2 of FIG. 1, illustrating the skeletal structure and support plates in greater detail according to one embodiment of the invention;

FIG. 3 is a front cross-sectional diagram of the thermal processing structure according to one embodiment of the invention;

FIG. 4 is a front perspective view of the thermal processing apparatus according to one embodiment of the invention;

FIG. 5 is a rear cross-sectional diagram, taken generally along lines 5-5 of FIG. 4, illustrating the skeletal structure and support plates in greater detail according to one embodiment of the invention;

FIG. 6 is a front cross-sectional diagram of the thermal processing structure according to one embodiment of the invention;

FIG. 7 is a front partial diagram illustrating the support plate gap and heating element of the thermal processing structure according to one embodiment of the invention.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The present invention describes a new method to support the resistance wire 11 in a heating system 10 by uniquely decoupling the load bearing components from the thermal element retention components, thereby achieving maximum thermal efficiency. The invention utilizes a unique skeletal frame structure 13 made of a plurality of axially spaced tubes 22, 28 of individually stacked support modules 21.

Heater coil support plates 12 are placed between the support modules 21 to form a rigid structure defining parallel spaces for heating elements 11 and defining an enclosed volume of space for substrates 14. Heating elements 11 are positioned in a cylindrical array of concentric rings, each heating element 11 being spaced from the hot wall process tube according to the specifications of the heating system 10. The number of support plates 12 and heating elements 11 can increase or decrease to provide more or less heat to the system 10.

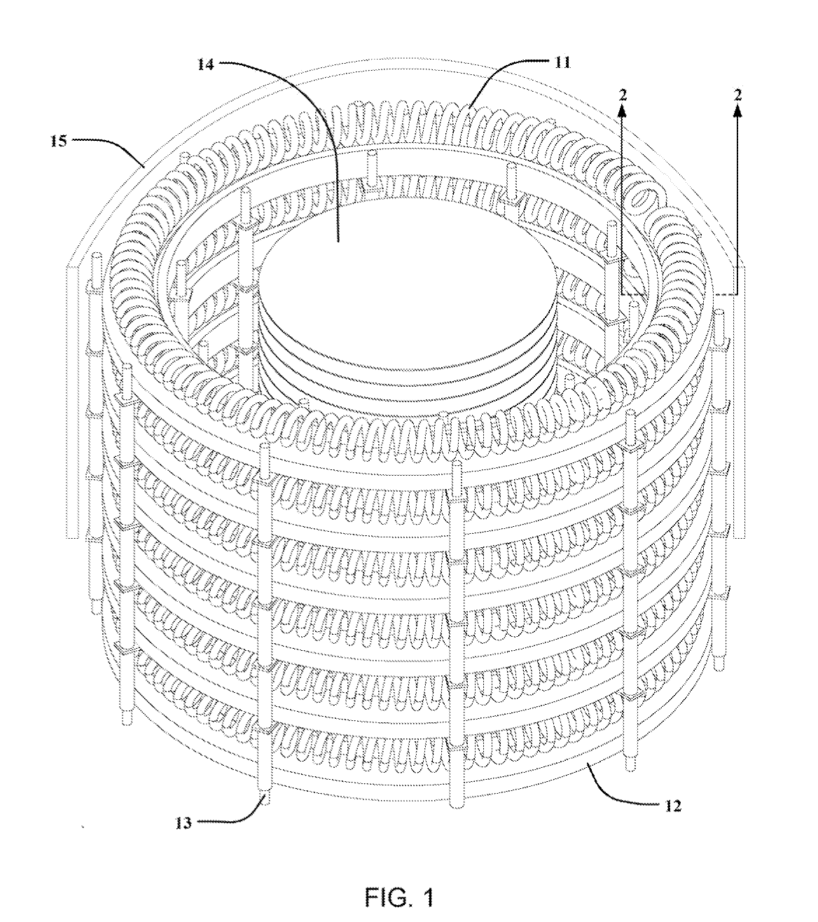

FIG. 1 is a diagram illustrating a system 10 in which one embodiment of the invention may be practiced. The system 10 represents a plurality of heating elements 11 which rest on a plurality of circular support plates 12 of high temperature material. The position of the support plates 12 is held in place by a rigid skeletal structure 13 of a high strength, low profile material. Each support plate 12 has an inner circumference and an outer circumference. The spacing of the support plates 12 can vary according to the specific requirements of the heating system 10 and the substrate 14.

The support plates 12 do not have any load bearing functions. As such, the material for the support plates 12 can be of minimum density and low thickness, creating a low mass heating system for faster heating and cooling of the substrate 14. Any number of support plates 12 can be used according to the specific requirements of the heating system 10 and substrate 14. The support plates 12 can be made of two pieces, with one piece to support the heating element 11 and the other to retain it. The support plates 12 can be made of Al₂O₃—SiO₂, or any other suitable material.

The heating elements 11 comprise coils of helically wound resistance heating wire made of Kanthal®, Nikrothal®, Super-Kanthal®, Molybdenum Discilicide, Iron Chromium Aluminum alloys, or other similar materials. The heating element 11 will expand as the temperature increases, and must be restricted properly to protect the substrate 14. A power source will energize the heating elements 11.

A shell of insulating material 15 surrounds the structure to create the desired thermal insulation for the system 10. The insulating material 15 does not have any load bearing function. As such, the density and thickness of the insulation 15 can vary independent of the load bearing structure for faster heating and cooling of the substrate 14. The insulating material 15 can be made of Al₂O₃—SiO₂, or any other suitable material.

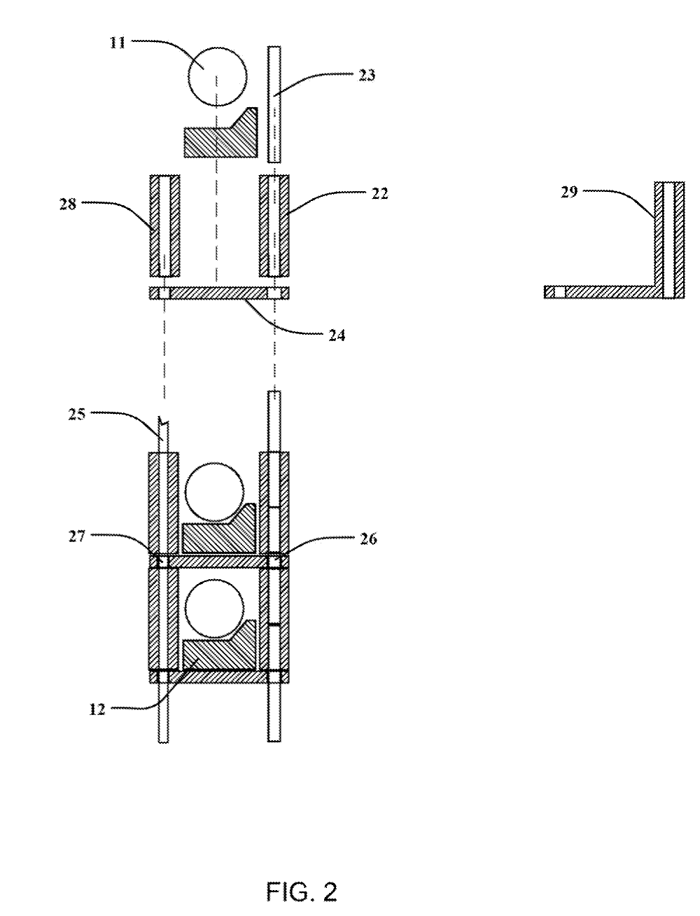

FIG. 2 is a diagram illustrating the skeletal structure 13 and support plates 12 in greater detail. The skeletal structure 13 comprises a series of individually linked support modules 21. Each support module 21 consists of an inner tube 22, an outer tube 28, an inner support rod 23, a flat stub 24, and an outer support rod 25. The inner and outer tubes 22, 28 are circular in shape and are machined to allow the inner support rod 23 and outer support rods 25, respectfully, to fit inside of them with minimal clearance. The distance between the support plates 12 can be modified by increasing or decreasing the height of the inner and outer tubes 22, 28 and inner and outer support rods 23, 250, respectively. Furthermore, there can be a single inner support rod 23 or outer support rod 25 that travels through all inner and outer tubes 22, 28 and flat stubs 24.

The flat stub 24 is also machined with an inner through hole 26 that the inner support rod 23 can fit through with minimal clearance, and an outer through hole 27 that the outer support rod 25 can fit through with minimal clearance. The inner and outer support rods 23, 25 vertically align all support modules. The flat stub 24 is placed in between the interlocking inner and outer tubes 22, 28 and inner and outer support rods 23, 25. There can be one or multiple flat stubs 24 that extend different directions and different distances under the support plates 12. The support modules 21 can be made of Al₂O₃—SiO₂, or any other suitable material.

The support modules 21 can be one or several pieces. In one embodiment, the inner tube 22 and the flat stub 24 may be molded as one piece 29. In another embodiment, the inner and outer tubes 22, 28 may have a rectangular shape.

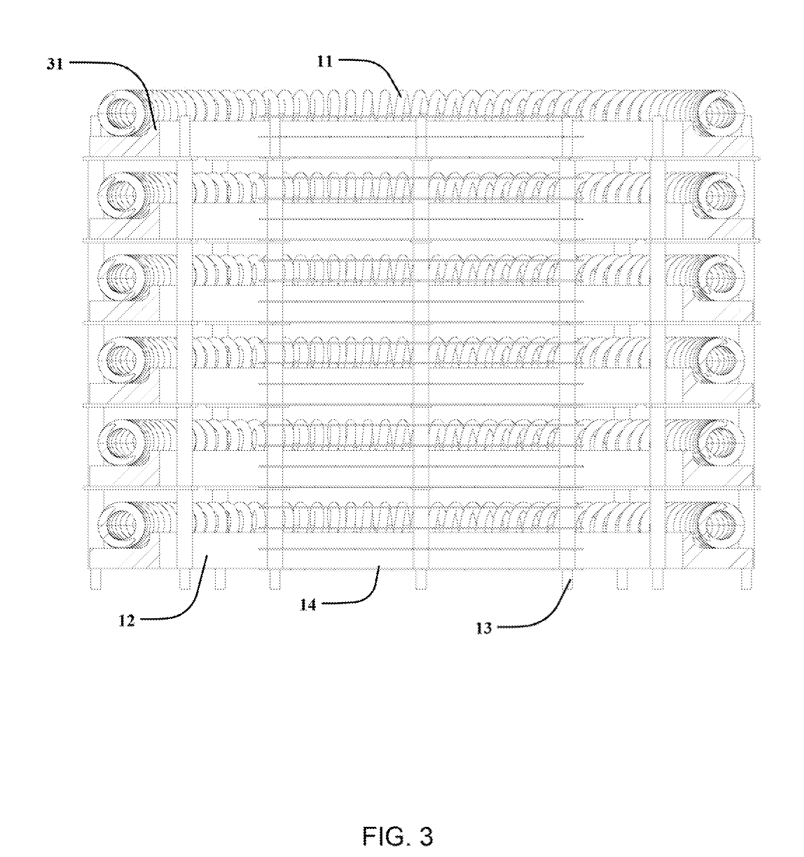

FIG. 3 is a diagram illustrating the support plates 12 in greater detail. The skeletal structure 13 maintains the support plates 12 between the inner 23 and outer 25 support rods. The support plates 12 retain the heating elements 11 from coming into contact with the substrate 14 with retaining lips 31 on their inner circumference. The retaining lips 31 can be short lips to allow for more radiation of the heating elements 11. Eyelets (not pictured) can be used liberally to maximize the amount of heat that radiates to the substrates 14. The inner tubes 22 and inner support rods 23 may provide additional support if the heating elements 11 are not retained by the support plates 12.

The relationship between the heating elements 11 and the structure that holds them is optimized by the low profile, high strength support modules 21, as well as the low density, low thickness support plates 12 and outside insulation 15. This combination allows for maximum thermal efficiency while maintaining rigid structural support for the heating system 10.

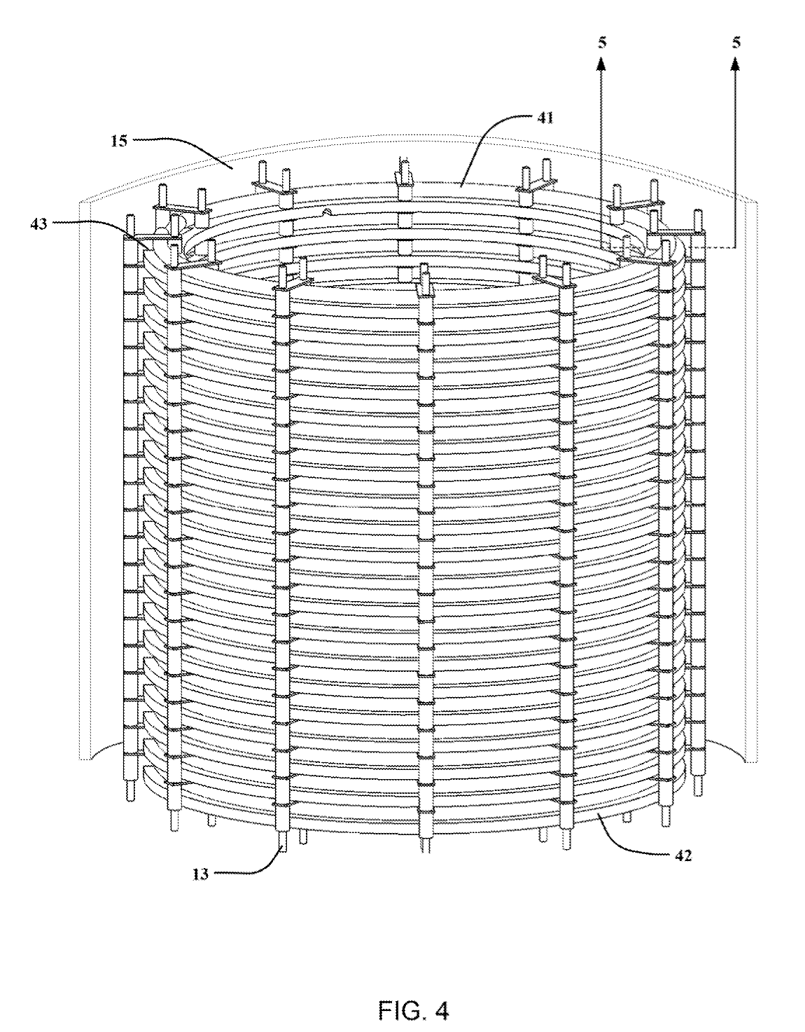

FIG. 4 is a diagram illustrating a system 40 in which one embodiment of the invention may be practiced. In this embodiment, there is one interconnected heating element 41 which rests upon a plurality of semi-circular support plates 42. Each support plate 42 comprises a gap 43, permitting the heating element 41 to go continue to the adjacent support plate 42. Each support plate 42 has an inner circumference and an outer circumference. The skeletal structure 13 maintains the support plates 42 on their inner circumference and outer circumference, and the skeletal structure 13 also retains the heating element 41 in their radial position to avoid contact with the substrate 14.

The support plates 42 do not have any load bearing functions. As such, the material for the support plates 42 can be of minimum density and low thickness, creating a low mass heating system for faster heating and cooling of the substrate 14. Any number of support plates 42 can be used according to the specific requirements of the heating system 40 and substrate 14. The support plates 42 can be made of Al₂O₃—SiO₂, or any other suitable material.

The heating element 41 comprises a solid, continuous, resistance heating wire made of Kanthal®, Nikrothal®, Super-Kanthal®, Molybdenum Discilicide, Iron Chromium Aluminum alloys, or other similar materials. The heating element 41 will expand as the temperature increases, and must be restricted properly to protect the substrate 14. A power source will energize the heating elements 41.

A shell of insulating material 15 surrounds the structure to create the desired thermal insulation for the system 40. The insulating material 15 does not have any load bearing function. As such, the density and thickness of the insulation 15 can vary independent of the load bearing structure for faster heating and cooling of the substrate 14. The insulating material 15 can be made of Al₂O₃—SiO₂, or any other suitable material.

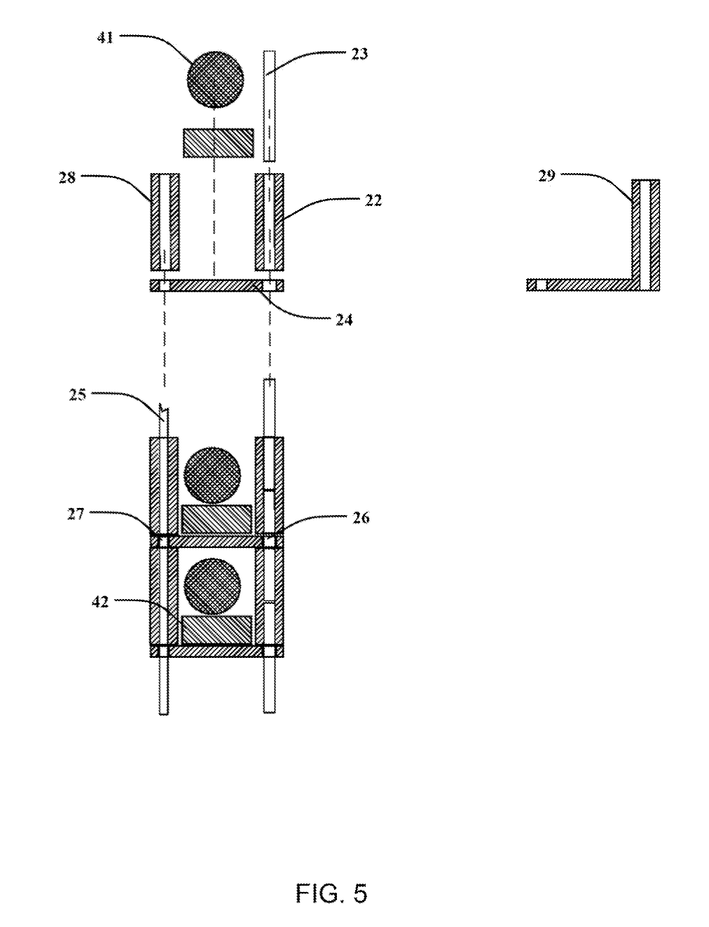

FIG. 5 is a diagram illustrating the skeletal structure 13 of this embodiment in greater detail. Each support module 21 consists of an inner tube 22, outer tube 28, an inner support rod 23, a flat stub 24, and an outer support rods 25. The inner and outer tubes 22, 28 are circular in shape and are machined to allow the inner support rod 23 and outer support rod 25, respectfully, to fit inside of them with minimal clearance. The distance between the support plates 42 can be modified by increasing or decreasing the height of the inner and outer tubes 22, 28 and inner and outer support rods 23, 25, respectively. Furthermore, there can be a single inner support rod 23 or outer support rod 25 that travels through all inner and outer tubes 22, 28 and flat stubs 24.

The flat stub 24 is also machined with an inner through hole 26 that the inner support rod 23 can fit through with minimal clearance, and an outer through hole 27 that the outer support rod 25 can fit through with minimal clearance. The inner and outer support rods 23, 25 vertically align all support modules. The flat stub 24 is placed in between the interlocking inner and outer tubes 22, 28 and inner and outer support rods 23, 25. There can be one or multiple flat stubs 24 that extend different directions and different distances under the support plates 42. The support modules 21 can be made of Al₂O₃—SiO₂, or any other suitable material.

The support modules 21 can be one or several pieces. In one embodiment, the inner tube 22 and the flat stub 24 may be molded as one piece 29. In another embodiment, the inner and outer tubes 22, 28 may have a rectangular shape.

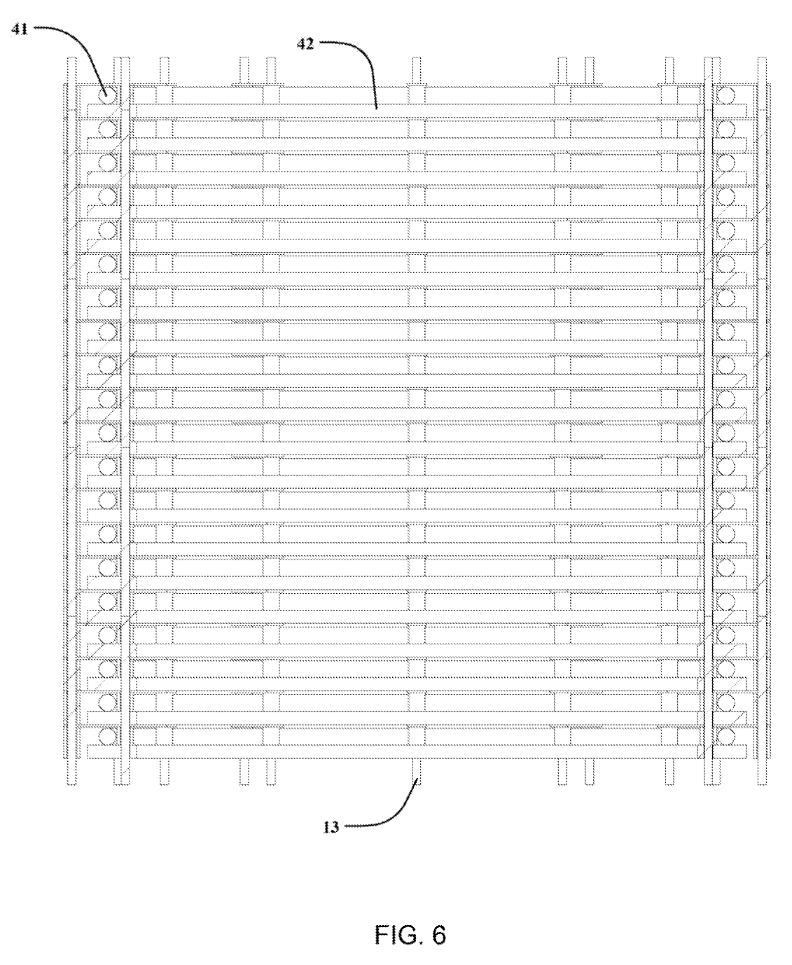

FIG. 6 is a diagram illustrating the support plates 42 in greater detail. The skeletal structure 13 maintains the support plates 42 on their inner and outer circumferences with the flat stubs 24 while also retaining the heating element 41 from damaging the substrate 14.

The relationship between the heating element 41 and the structure that holds them is optimized by the low profile, high strength support modules 21, as well as the low density, low thickness support plates 42 and outside insulation 15. This combination allows for maximum thermal efficiency while maintaining rigid structural support for the heating system 40.

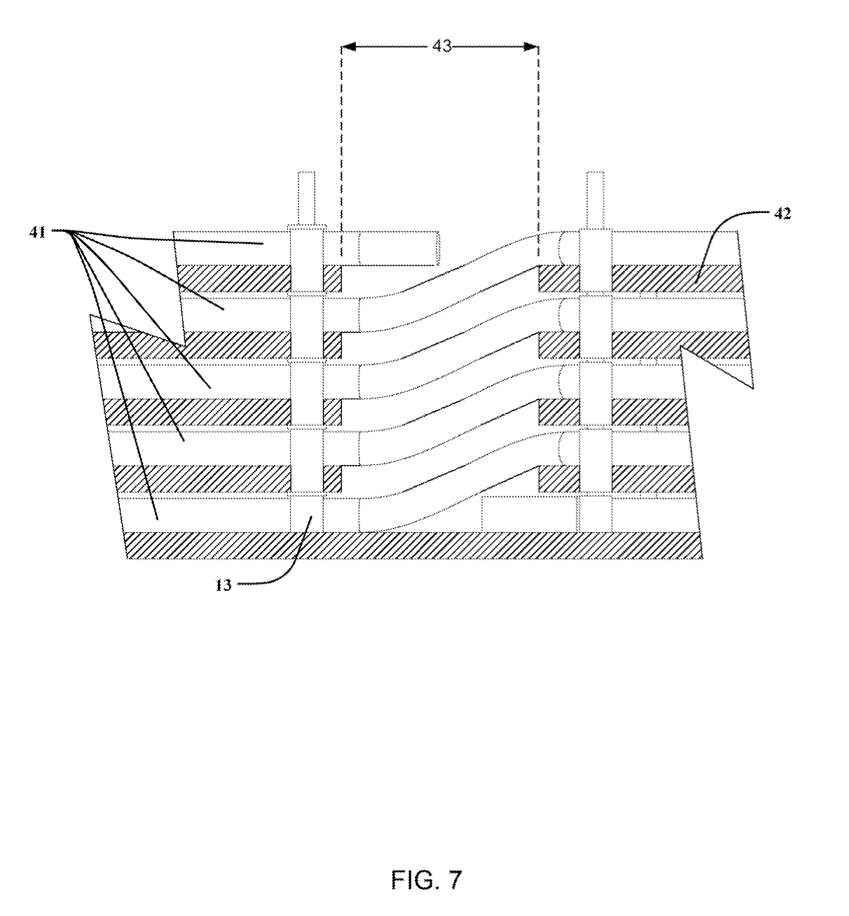

FIG. 7 is a diagram illustrating the support plate 42 gaps 43 according to one embodiment of the invention. Here, the solid and continuous resistance heating element 41 rests on each support plate 42 as it travels through the gaps 43 of the support plates 42. The overall shape of the heating element 41 inside of the system 40 can generally be described as a spiral.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A thermal processing apparatus comprising:
a plurality of circular support plates, each support plate having an outer circumference and an inner circumference, each inner circumference having a retaining lip, wherein the plurality of support plates do not provide load bearing support to the thermal processing apparatus;
a plurality of circular helicoid heating elements positioned between the inner and outer circumference of the plurality of support plates, the plurality of helicoid heating elements vertically supported by the plurality of support plates, each helicoid heating element radially retained by a retaining lip;
an insulation layer surrounding the thermal processing apparatus; and
a skeletal structure for load bearing support of the thermal processing apparatus.

2. The thermal processing apparatus of claim 1, wherein the skeletal structure comprises a plurality of support modules, each support module comprising an inner support rod, an outer support rod, an inner tube, an outer tube, and a flat stub, wherein the flat stub is positioned between adjacent inner and outer tubes.

3. The thermal processing apparatus of claim 2, wherein the length of the inner and outer tubes define the space between the plurality of support plates and wherein the inner and outer tubes retain the plurality of support plates radially.

4. The thermal processing apparatus of claim 3, wherein the inner support rods and inner tubes retain the plurality of support plates on their inner circumference, wherein the outer support rods and outer tubes retain the support plates on their outer circumferences, and wherein the flat stubs retain the plurality of support plates vertically.

5. The thermal processing apparatus of claim 4, wherein the inner support rods vertically align all inner tubes and flat stubs along the inner circumference of the plurality of support plates.

6. The thermal processing apparatus of claim 5, wherein the outer support rods vertically align all outer tubes and flat stubs along the outer circumference of the plurality of support plates.

7. The thermal processing apparatus of claim 6, wherein a single outer support rod vertically aligns all outer tubes and flat stubs along the outer circumference of the plurality of support plates, and a single inner support rod vertically aligns all inner tubes and flat stubs along the inner circumference of the plurality of support plates.

8. The thermal processing apparatus of claim 1, wherein the plurality of support plates are made of Al₂O₃—SiO₂.

9. The thermal processing apparatus of claim 1, wherein the plurality of heating elements are made of Iron Chromium Aluminum alloys or Molybdenum Discilicide.

10. A thermal processing apparatus comprising:
a plurality of semi-circular support plates, each support plate having an outer circumference and an inner circumference, each support plate having a gap, wherein the plurality of support plates do not provide load bearing support to the thermal processing apparatus;
a solid and continuous resistance heating element positioned between the inner and outer circumference of the plurality of support plates, the heating element being vertically supported by the plurality of support plates, wherein the heating element travels around and through the gap of each support plate, creating a generally spiral shape;
an insulation layer surrounding the thermal processing apparatus; and
a skeletal structure for load bearing support of the thermal processing apparatus.

11. The thermal processing apparatus of claim 10, wherein the skeletal structure comprises a plurality of support modules, each support module comprising an inner support rod, an outer support rod, an inner tube, an outer tube, and a flat stub, wherein the flat stub is positioned between adjacent inner and outer tubes.

12. The thermal processing apparatus of claim 11, wherein the length of the inner and outer tubes define the space between the plurality of support plates and wherein the inner and outer tubes retain the plurality of support plates and heating element radially.

13. The thermal processing apparatus of claim 12, wherein the inner support rods and inner tubes retain the plurality of support plates on their inner circumference, wherein the outer support rods and outer tubes retain the support plates on their outer circumferences, and wherein the flat stubs retain the plurality of support plates vertically.

14. The thermal processing apparatus of claim 13, wherein the inner support rods vertically align all inner tubes and flat stubs along the inner circumference of the plurality of support plates.

15. The thermal processing apparatus of claim 14, wherein the outer support rods vertically align all outer tubes and flat stubs along the outer circumference of the plurality of support plates.

16. The thermal processing apparatus of claim 15, wherein a single outer support rod vertically aligns all outer tubes and flat stubs along the outer circumference of the plurality of support plates, and a single inner support rod vertically aligns all inner tubes and flat stubs along the inner circumference of the plurality of support plates.

17. The thermal processing apparatus of claim 10, wherein the plurality of support plates are made of Al₂O₃—SiO₂.

18. The thermal processing apparatus of claim 10, wherein the heating element is made of Iron Chromium Aluminum alloys or Molybdenum Discilicide.
